(19) United States
(12) Patent Application Publication
(10) Pub. No.: US 2002/0028008 A1
(43) Pub. Date: Mar. 7, 2002

(54) Automatic detection of lung nodules from high resolution CT images

(76) Inventors: Li Fan, Plainsboro, NJ (US); Jainzhong Qian, Princeton, NJ (US); Guo-Qing Wei, Plainsboro, NJ (US); Carol L. Novak, Newton, PA (US)

Correspondence Address: Siemens Corporation, Intellectual Property Department, 186 Wood Avenue South, Iselin, NJ, 08830, US

(21) Appl. No.: 09/840,266

(22) Filed: Apr. 23, 2001

Related U.S. Application Data
(60) Provisional application No. 60/230,772, filed on Sep. 7, 2000.

(51) Int. Cl. G06K 9/62; G06K 9/34; G06K 9/00

(52) U.S. Cl. 382/131; 382/170; 382/173; 382/224

(57) ABSTRACT

A method for automatically detecting lung nodules from MSHR CT images includes defining a volume of interest (VOI) for a lung volume in an MSHR CT image. The lung volume is examined using the VOI, including, determining a local histogram of intensity and adaptive threshold values for segmenting the VOI to obtain seeds. Each seed is examined to detect lung nodules therefrom, including segmenting anatomical structures represented by the seed by applying a segmentation method that adaptively adjusts a segmentation threshold value based on histogram analysis of the seed to extract the structures based on three-dimensional connectivity and histogram intensity information, and classifying each structure as a lung nodule or a non-nodule based on a priori knowledge corresponding to lung nodules and related structures. The lung nodules are displayed. The lung nodules are analyzed, including automatically quantifying lung nodule features to provide an automatic detection decision.

### CROSS-REFERENCE TO RELATED APPLICATIONS

This is a non-provisional application claiming the benefit of provisional application Ser. No. 60/230,772, filed on Sep. 7, 2000, the disclosure of which is incorporated herein by reference.

This application is related to the application, Attorney Docket Number 2001E03249, entitled “Interactive Computer-Aided Diagnosis (ICAD) Method and System for Assisting Diagnosis of Lung Nodules in Digital Volumetric Medical Images”, which is commonly assigned and concurrently filed herewith, and the disclosure of which is incorporated herein by reference. This application is also related to U.S. Ser. No. 09/606,564, entitled “Computer-aided Diagnosis of Three Dimensional digital image data”, filed on Jun. 29, 2000, which is commonly assigned herewith, and the disclosure of which is incorporated herein by reference.

### BACKGROUND

1. Technical Field

The present invention generally relates to medical detection systems and, in particular, to a method and system for automatically detecting lung nodules from Multi-Slice High Resolution Computed Tomography (MSHR CT) images.

2. Background Description

Lung cancer has been reported as the second most commonly diagnosed cancer for both men and women, as well as the leading cause of cancer death in America. Meanwhile, detection of certain lung cancers at an early stage has been shown to significantly improve the five-year survival rate. Therefore, it is highly desirable to detect lung nodules at an early stage via non-invasive methods. Multi-Slice High Resolution Computed Tomography (MSHR CT) scanning provides such a way in which nodules from 2 to 30 mm in diameter can be imaged anywhere in the lung volume.

However, the large amount of MSHR CT data presents formidable challenges to physicians. A typical multi-slice high-resolution scan with slice thickness of 1 to 1.5 mm may have 300 or more image slices. If Computed Tomography (CT) for lung cancer screening becomes widespread, there will be a tremendous demand for such examinations. Clearly, it is time consuming and impractical for a physician to study every single image slice. Accordingly, it would be desirable and highly advantageous to have an automatic nodule detection method and system.

### SUMMARY OF THE INVENTION

The problems stated above, as well as other related problems of the prior art, are solved by the present invention, a method and system for automatically detecting lung nodules from Multi-Slice High Resolution Computed Tomography (MSHR CT) images.

According to an aspect of the invention, there is provided a method for automatically detecting lung nodules from Multi-Slice High Resolution Computed Tomography (MSHR CT) images. A volume of interest (VOI) is defined for moving through a lung volume in an MSHR CT image, based on MSHR CT image data. The lung volume is examined using the VOI, including, determining a local histogram of intensity inside the VOI, and determining adaptive threshold values for segmenting the VOI to obtain seeds. Each of the seeds is examined to detect the lung nodules therefrom, including, segmenting anatomical structures represented by the seeds by applying a segmentation method to the seeds that adaptively adjusts a segmentation threshold value based on a local histogram analysis of the seeds to extract the anatomical structures based on three-dimensional connectivity and intensity information corresponding to the local histogram, and classifying each of the segmented, anatomical structures as one of a lung nodule or a non-nodule, based on a priori knowledge corresponding to the lung nodules and related, predefined anatomical structures. The lung nodules are displayed. The lung nodules are analyzed, including, automatically quantifying features of the lung nodules to provide an automatic detection decision for each of the lung nodules.

According to another aspect of the invention, the step of examining the lung volume includes the step of determining a curvature of a one-dimensional histogram curve corresponding to the local histogram.

According to yet another aspect of the invention, the step of examining the lung volume includes the step of determining positive and negative curvature extrema of the curvature of the one-dimensional histogram curve.

According to still yet another aspect of the invention, the step of examining the lung volume includes the step of determining the adaptive segmentation threshold value based upon an analysis of positive and negative curvature extrema of the curvature of the one-dimensional histogram curve.

According to a further aspect of the invention, the classifying step includes the step of excluding non-nodule structures from further evaluation.

According to a yet further aspect of the invention, the excluding step includes the step of applying a depth-first search to the seeds in a direction of a Z-axis of the VOI, to exclude any of the seeds representing the non-nodules structures.

According to an additional aspect of the invention,_the analyzing step includes the step of receiving, from a user, a final detection decision for each of the lung nodules, the final detection decision overriding the automatic detection decision.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram of a system 100 for automatically detecting lung nodules from Multi-Slice High Resolution Computed Tomography (MSHR CT) images, according to an illustrative embodiment of the present invention;

FIGS. 2A and 2B are diagrams illustrating an example of a detected nodule candidate 200, according to an illustrative embodiment of the present invention;

FIG. 3 is a flow diagram illustrating a method 300 for automatically detecting lung nodules from Multi-Slice High Resolution Computed Tomography (MSHR CT) images, according to an illustrative embodiment of the present invention;

FIG. 4A is a plot of a local histogram within a volume of interest (VOI) surrounding an object of interest, according to an illustrative embodiment of the present invention; and

FIG. 4B is a close-up view of the local histogram of FIG. 4A in the intensity range where segmentation thresholds are set, according to an illustrative embodiment of the present invention;

FIG. 4C is a plot of a curve illustrating the corresponding curvature extrema of the local histogram of FIGS. 4A and 4B, from which an adaptive threshold value is determined, according to an illustrative embodiment of the present invention.

### DETAILED DESCRIPTION OF PREFERRED EMBODIMENTS

The present invention is directed to a method and system for automatically detecting lung nodules from Multi-Slice High Resolution Computed Tomography (MSHR CT) images.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

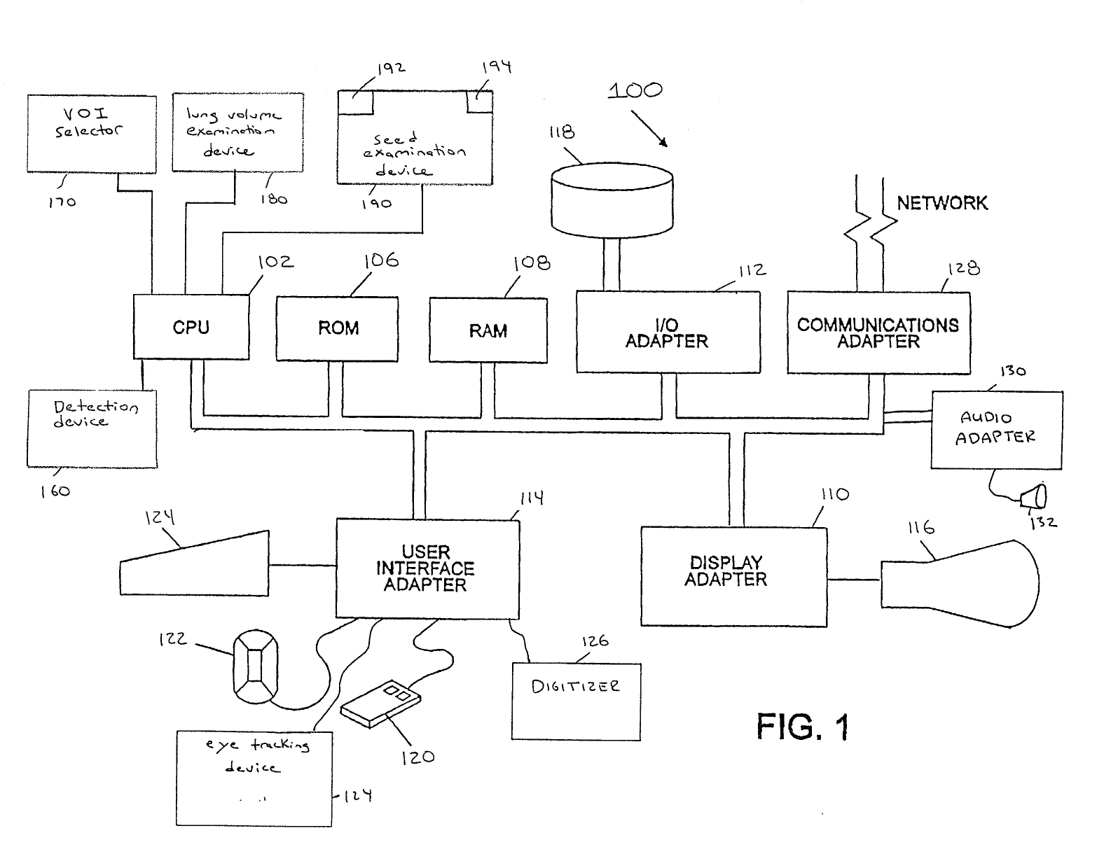

FIG. 1 is a block diagram of a system 100 for automatically detecting lung nodules from Multi-Slice High Resolution Computed Tomography (MSHR CT) images, according to an illustrative embodiment of the present invention. The system 100 includes at least one processor (CPU) 102 operatively coupled to other components via a system bus 104. A read only memory (ROM) 106, a random access memory (RAM) 108, a display adapter 110, an I/O adapter 112, and a user interface adapter 114 are operatively coupled to the system bus 104.

A display device 116 is operatively coupled to the system bus 104 by the display adapter 110. A disk storage device (e.g., a magnetic or optical disk storage device) 118 is operatively coupled to the system bus 104 by the I/O adapter 112.

A mouse 120, a keyboard 122, and an eye tracking device 124 are operatively coupled to the system bus 104 by the user interface adapter 114. The mouse 120, keyboard 122, and eye tracking device 124 are used to aid in the selection of suspicious regions in a digital medical image.

A volume of interest (VOI) selector 170, a lung volume examination device 180, a detection device 160, and a seed examination device 190 which includes a segmentation device 192 and a classifier 194 are also included in the system 100. While the VOI selector 170, the lung volume examination device 180, the detection device 160, and the seed examination device 190 (including the segmentation device 192 and the classifier 194) are illustrated as part of the at least one processor (CPU) 102, these components are preferably embodied in computer program code stored in at least one of the memories and executed by the at least one processor 102. Of course, other arrangements are possible, including embodying some or all of the computer program code in registers located on the processor chip. Given the teachings of the invention provided herein, one of ordinary skill in the related art will contemplate these and various other configurations and implementations of the VOI selector 170, the lung volume examination device 180, the detection device 160, and the seed examination device 190 (including the segmentation device 192 and the classifier 194), as well as the other elements of the system 100, while maintaining the spirit and scope of the present invention.

The system 100 may also include a digitizer 126 operatively coupled to system bus 104 by user interface adapter 114 for digitizing an MSHR CT image of the lungs. Alternatively, digitizer 126 may be omitted, in which case a digital MSHR CT image may be input to system 100 from a network via a communications adapter 128 operatively coupled to system bus 104.

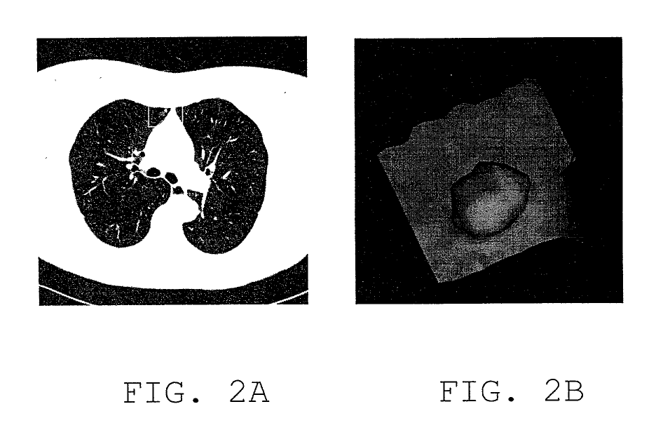

FIGS. 2A and 2B are diagrams illustrating an example of a detected nodule candidate 200, according to an illustrative embodiment of the present invention. In particular, FIG. 2A illustrates the nodule located on the original CT image, and FIG. 2B illustrates a three-dimensional (3-D) surface rendering on the nodule.

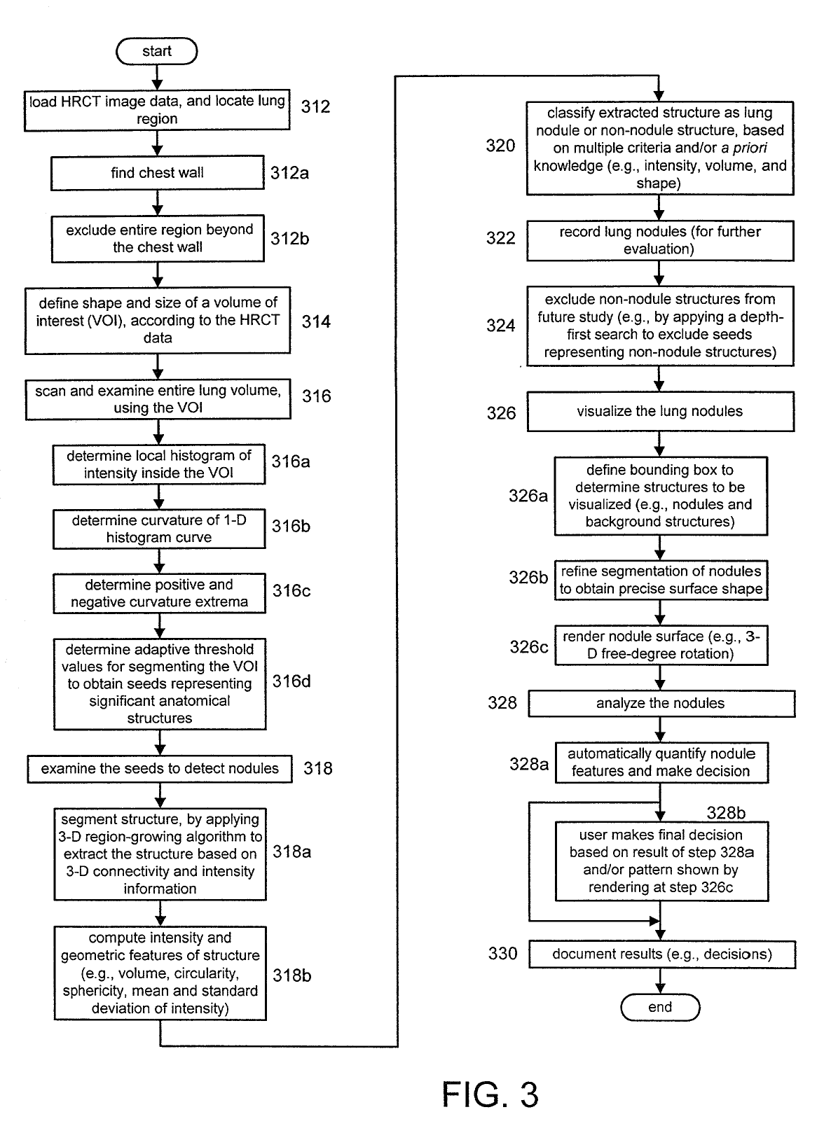

FIG. 3 is a flow diagram illustrating a method 300 for automatically detecting lung nodules from Multi-Slice High Resolution Computed Tomography (MSHR CT) images, according to an illustrative embodiment of the present invention.

A general description of the present invention will now be provided with respect to FIG. 3 to introduce the reader to the concepts of the invention. Subsequently, more detailed descriptions of various aspects of the invention will be provided with reference to the steps of FIG. 3. After MSHR CT image data is loaded, preprocessing is carried out to locate the lung region (step 312). The chest wall is located (step 312a), and the entire region beyond the chest wall is excluded (step 312b).

A shape and size of a volume of interest (VOI) is defined according to the MSHR CT data by the VOI selector 170 (step 314). In particular, the VOI is set up to move through the entire lung volume for the purpose of nodule detection.

The whole lung volume is scanned and examined using the VOI by the lung volume examination device 180 (step 316). For each move of the VOI, the system automatically determines: the local histogram of intensity inside the VOI (step 316a); the curvature of the 1-D histogram curve (step 316b); the positive and negative curvature extrema (step 316c); and the adaptive threshold values for segmenting the VOI to obtain seeds (step 316d). These seeds represent the significant anatomical structures, including lung nodules, vessels, airway walls, and other tissues. Anatomical structures which may be considered seeds are preferably, but not necessarily, pre-specified.

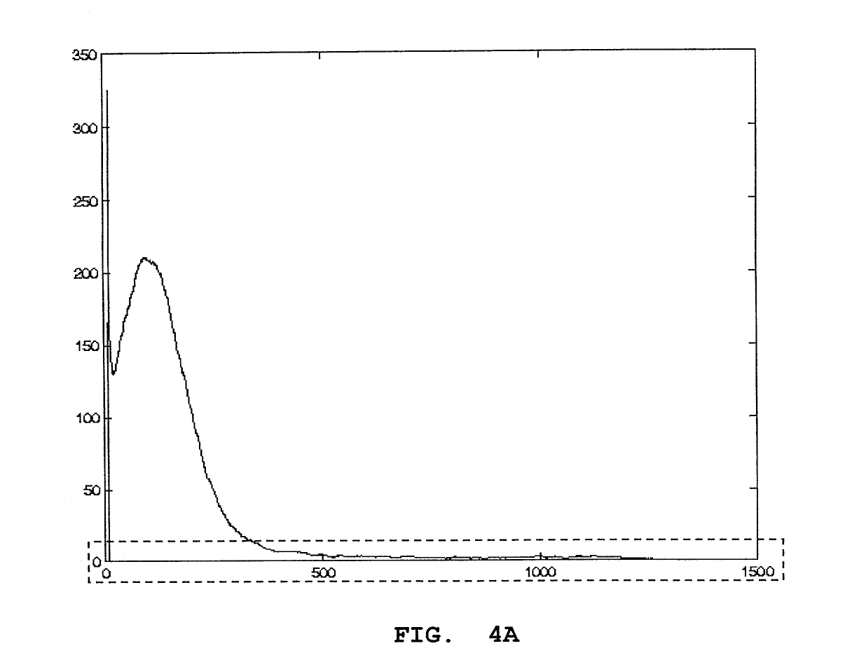

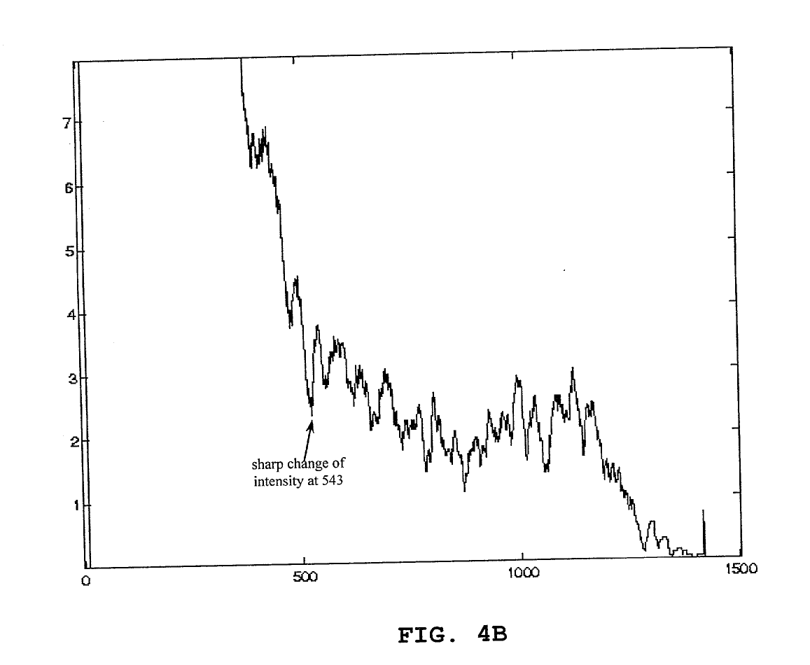

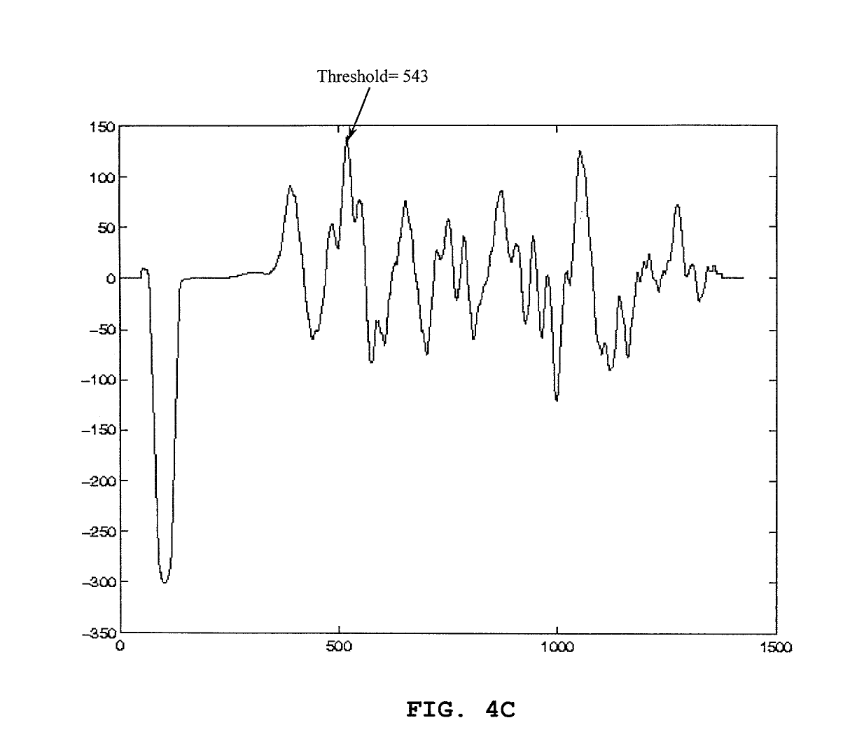

FIG. 4A is a plot of a local histogram within a volume of interest (VOI) surrounding an object of interest, according to an illustrative embodiment of the present invention. The plot of FIG. 4A corresponds to step 316a of FIG. 3. FIG. 4B is a close-up view of the local histogram of FIG. 4A in the intensity range where segmentation thresholds are set. As can be seen from FIGS. 4A and 4B, multiple peaks exist in the intensity range between 300 to 600 and make the threshold selection very difficult.

FIG. 4C is a plot of a curve illustrating the corresponding curvature of the local histogram of FIGS. 4A and 4B, according to an illustrative embodiment of the present invention. A segmentation threshold is adaptively set to be 543 based on curvature extrema analysis, as described with respect to step 316c of FIG. 3.

The seeds are examined to detect lung nodules by the seed examination device 190 (step 318). In particular, for each seed obtained from step 316d, steps 318a and 318b are performed to examine the corresponding structure.

The corresponding structure is segmented by he segmentation device 192 (step 318a). A segmentation method based on local histogram analysis is applied to the seeds to extract the structure based on three-dimensional connectivity and the previously obtained intensity information from step 316d.

The intensity and geometric features of the segmented structure are computed (step 318b). That is, the structure is described by intensity and geometric parameters including but not limited to position, diameter, volume, circularity, sphericity, mean and standard deviation of intensity.

The extracted structure is classified as a lung nodule or non-nodule structure by the classifier 194, based on multiple criteria and/or a priori knowledge about lung nodules and other structures, such as intensity, volume, and shape (step 320). If the segmented structure is categorized as a lung nodule at step 320, then the segmented structure is automatically recorded for further study/evaluation (step 322).

Non-nodule structures are excluded from future study/evaluation (step 324). In one embodiment of the invention, a depth-first search, in the direction of the Z-axis of the volume, is applied to exclude seeds representing non-nodule structures from future study/evaluation. In this way, computation time is dramatically saved.

The lung nodules are visualized (step 326). A “Candidate Tour” is automatically launched so that every detected nodule is indicated on the original CT images, one nodule after the other nodule and so on. A Candidate Tour is described in detail in the above referenced application, Attorney Docket Number 2001E03249, entitled “Interactive Computer-Aided Diagnosis (ICAD) Method and System for Assisting Diagnosis of Lung Nodules in Digital Volumetric Medical Images”. For each candidate, further processing is made for visualization purposes, as described in steps 326a-326c.

A bounding box is defined for the detected nodule (step 326a). Step 326a automatically determines the structures to be visualized, which include the detected lung nodule and necessary background structures to make the visualization easier to understand. This visualization is of great help when lung nodules are attached to the chest wall or vessels.

The segmentation of the lung nodules is refined to obtain a precise surface shape (step 326b). It is to be appreciated that refined segmentations provide more detailed surface features to help physicians diagnose the lung nodules.

The lung nodule surface is rendered, e.g., a shown in FIG. 2 (step 326c). A three-dimensional free rotation is provided to facilitate the study of the surface.

The lung nodules are analyzed to render a detection decision for output, e.g., to a user, storage medium, and so forth (step 328). Two illustrative approaches are now described for making the detection decision. In the first approach, the lung nodule features (e.g., the distribution of calcified areas) are automatically quantified and the detection decision is made by detection device 160 (step 328a). In the second approach, the physicians make the final detection decision based on: (1) the automatic analysis results from step 328a; and/or (2) the patterns shown by surface rendering from step 326c (step 328b). In the case of the physician making the detection decision, such decision overrides the decision made by the detection device 160 at step 328a.

The study is documented (step 330). In particular, after the patient study is finished, the analysis results (e.g., measurements, analysis results of steps 328a and/or 328b, and so forth) are automatically saved for future use. This is very useful for follow-up examination and treatment monitoring.

More detailed descriptions of various aspects of the invention will be provided with reference to the steps of FIG. 3, according to an illustrative embodiment of the invention.

Computational efficiency is an important factor for evaluating a lung nodule detection method. When MSHR CT scans are performed and hundreds of slice images need to be examined, this issue becomes more critical. We reduce the computational complexity by extracting the lung area from the original images (in step 312) so that the region of interest to be examined is narrowed down.

On two-dimensional (2-D) axial slices, lung regions are usually dark areas with some bright structures inside, while surrounding tissues, such as the chest wall and heart, appear to be much brighter regions connected together. Clear boundaries between the lung area and non-lung area can almost always be observed. A global threshold is set by automatically analyzing the histogram of the entire volumetric data to optimally distinguish lung tissues that contain air content from other solid tissues that have higher mass density, such as muscle, bone, and vessels. We then apply thresholding to every two-dimensional slice and label the resultant binary image. The chest wall connected with the heart is usually the largest structure labeled and therefore can be easily identified. The lung region is then obtained by excluding the chest wall and beyond (in step 312b).

In step 314,a binary volumetric data is generated after applying the global threshold and extracting the lung area on every two-dimensional slice. With respect to step 316, voxels that are set as ON in this data represent significant anatomical structures, including nodules, blood vessels, bronchial walls, and other tissues. They will serve as initial seeds to examine the structures of interest. Note that since the threshold is set to achieve global optimization, anatomical structures may be broken into pieces after segmentation. Multiple seeds contained in the binary image data may therefore represent the same anatomical structure.

With respect to step 316d, segmentation of target structures plays an important role in the whole scheme. All the quantitative measurements and further classification are based on the segmentation results. Segmentation is very sensitive to threshold and there is a tradeoff in setting this value. If the threshold is too high, vessels will lose some weak parts and appear to be nodule-like. However, if the threshold is set too low, noise will be enhanced and may make a nodule appear to be a vessel. Both problems may be exacerbated in low-dose images used for screening.

The threshold should be chosen according to local information in the suspicious area. A VOI is set up to scan the entire lung volume (in step 314). The shape and size of the VOI are defined according to the CT data characteristics. Once the VOI is centered at a seed, the local histogram of intensity is examined (in step 316b, and optionally step 316c) to properly set the threshold (in step 316d). Ideally, this curve has two distinct peaks, which correspond to the relatively bright anatomical structure and its dark surroundings. The valley between the peaks can then be chosen as the threshold to segment the target structure (in step 316d).

However, the situation is more complicated in many cases. For example, there may be multiple structures that have different intensity characteristics, like in the central area of the lungs where various anatomical structures exist. Even when only one anatomical structure is present, its intensity may vary due to the partial volume effect. This occurs frequently with small vessels. In either case, there will be no distinct valley in the histogram. Instead, we adaptively set the threshold for target structure segmentation by finding the curvature extrema of the local histogram (in step 316c). Noticing that peaks in the curvature plot correspond to sharp drops in the histogram, and reflect abrupt changes in intensity distribution, the threshold can be set as the intensity value where the sharpest change occurs.

Once the threshold has been determined, a three-dimensional region growing method is applied to segment the target structure (in step 318a). It begins with the seed under consideration; all the voxels that have intensity values higher than the threshold and that are connected to the known part will be added into the segmentation result.

However, multiple seeds may belong to the same anatomical structure. Computation will be inefficient if every seed is examined and the same structure is segmented repeatedly. To reduce the computation redundancy, the binary volumetric data that contains all the seeds is updated after each segmentation. Seeds will be turned off if they are determined to be connected to the seed that was just examined. In this way, non-nodule structures, such as, for example, vessels and the airway tree, are examined once and then quickly excluded from future study. This has been shown to dramatically reduce the number of seeds on each slice and to save computation time.

With respect to step 320, the structure is classified as a nodule candidate or a non-nodule structure. This is done by measuring (in step 318b) and analyzing geometric properties that characterize the structure after it has been segmented. While five illustrative properties are described herein (i.e., diameter, volume, sphericity, mean intensity value and standard deviation of intensity), of course, other properties may be employed in place of, or in addition to, some, none, or all of the five illustrative properties.

Although the parameters diameter and volume are not independent of each other and contain redundant information, both are still measured in the illustrative example of FIG. 3. This is because it is still common for radiologists to use diameter to express the size of a lung nodule. However, when talking about growth rates in follow-ups, the volume parameter is more often used.

Sphericity is the three-dimensional counterpart of compactness, and is defined as the fraction of a structure's volume to the volume of a sphere that encompasses it. This parameter characterizes the three-dimensional shape of a structure of interest. Although nodules and blood vessels may both have circular shapes on two-dimensional slices, their three-dimensional shapes are totally different. Lung nodules are sphere-like with high compactness, while blood vessels are tube-like, with very low compactness. It has been found that circularity and sphericity are very useful in separating lung nodules from small vessels. Cutoff values of circularity and sphericity are empirically set. Structures that are larger than 2 mm in diameter and have circularity and sphericity measurements higher that the cutoff values will be considered as lung nodule candidates, and their position recorded. Different from other nodule detection methods, the detection method of the present invention computes the 2D features, including circularity, mean and standard deviation of intensity not only on axial slices, but also on cutting cross-sections produced by a 360-degree-spin-plane method in the volume. The 360-degree-spin-plane method is described in the above referenced application, U.S. Ser. No. 09/606,564, entitled “Computer-aided Diagnosis of Three Dimensional digital image data”.

The last two parameters, mean intensity value and standard deviation, do not contribute significantly to the lung nodule detection. However, they contain important information about calcification, and can be used to decide if a lung nodule candidate is benign or malignant. Usually, a lung nodule is considered benign if it is highly calcified or has certain patterns of distribution of calcified spots. There are also certain patterns associated with malignant lung nodules.

In sum, the invention is designed to automatically detect and analyze lung nodules from MSHR CT images, so that radiologists can be freed from the heavy burden of reading through hundreds of image slices. Some of the many advantageous characteristics of the present invention will now be described. The invention is sensitive to lung nodules while having low false-positive rates. Usually, lung nodules appear in slice images as nearly circular-shaped opacities, which are similar to cross-sections of vessels. Accordingly, most existing detection methods have a high false-positive rate. The invention solves this problem by incorporating a priori anatomical knowledge of pulmonary structures and making full use of the three-dimensional image information. Multiple criteria, including geometric and intensity criteria, are set up for categorizing the suspicious volume of interest (VOI) as a lung nodule or non-nodule structure. Furthermore, the segmentation method of the present invention is able to adjust the segmentation threshold based on local histogram analysis, which distinguishes the segmentation method from other approaches in coping with the higher amounts of noise in low-dose screening images.

The present invention is computationally efficient. It is very desirable that the automatic detection can be done quickly so that the examining physician may validate the results without adding a significant time burden. Two steps are performed to achieve this goal. First, the lung region is located so that the search region for suspicious structures is narrowed down. Then, for each suspicious structure, the three-dimensional connectivity is checked and recorded. In this way, non-nodule structures, such as vessels and the airway tree, are examined once and then quickly excluded from future study.

The present invention is easy to use. The invention also has routines associated with the detection method to facilitate the examination of patient study for physicians. Such functions include surface rendering of the structure of interest, parameter measurement, documentation of suggested nodule candidates, and so forth. These and other features and advantages of the present invention are readily ascertained by one of ordinary skill in the art.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method for automatically detecting lung nodules from Multi-Slice High Resolution Computed Tomography (MSHR CT) images, comprising the steps of:
defining a volume of interest (VOI) for moving through a lung volume in an MSHR CT image, based on MSHR CT image data;
examining the lung volume using the VOI, including,
determining a local histogram of intensity inside the VOI; and
determining adaptive threshold values for segmenting the VOI to obtain seeds;
examining each of the seeds to detect the lung nodules therefrom, including,
segmenting anatomical structures represented by the seeds by applying a segmentation method to the seeds that adaptively adjusts a segmentation threshold value based on a local histogram analysis of the seeds to extract the anatomical structures based on three-dimensional connectivity and intensity information corresponding to the local histogram; and
classifying each of the segmented, anatomical structures as one of a lung nodule or a non-nodule, based on a priori knowledge corresponding to the lung nodules and related, pre-defined anatomical structures;
displaying the lung nodules; and
analyzing the lung nodules, including,
automatically quantifying features of the lung nodules to provide an automatic detection decision for each of the lung nodules.

2. The method according to claim 1, wherein said defining step comprises the step of locating a lung region in the MSHR CT image, the lung volume being disposed within the lung region.

3. The method according to claim 2, wherein said locating step comprises the step of locating a chest wall and excluding an entire region behind the chest wall.

4. The method according to claim 1, wherein said defining step comprises the step of defining a shape and a size of the VOI.

5. The method according to claim 1, wherein said step of examining the lung volume comprises the step of determining a curvature of a one-dimensional histogram curve corresponding to the local histogram.

6. The method according to claim 5, wherein said step of examining the lung volume comprises the step of determining positive and negative curvature extrema of the curvature of the one-dimensional histogram curve.

7. The method according to claim 6, wherein said step of examining the lung volume comprises the step of determining the adaptive segmentation threshold value based upon an analysis of positive and negative curvature extrema of the curvature of the one-dimensional histogram curve.

8. The method according to claim 1, wherein said step of examining each of the seeds comprises the step of computing intensity and geometric features of the segmented, anatomical structures.

9. The method according to claim 8, wherein the intensity and geometric features are computed from at least some cutting cross sections produced by a 360-degree-spin-plane method applied in the VOI, and the intensity and geometric features comprise at least some of a position, a volume, a circularity, a sphericity, and a mean and standard deviation of intensity.

10. The method according to claim 1, wherein the a priori knowledge comprises at least some of an intensity, a volume, and a shape of the lung nodules and the related, predefined anatomical structures.

11. The method according to claim 1, wherein said classifying step comprises the step of automatically recording a segmented, anatomical structure for further evaluation, when the segmented, anatomical structure is classified as the lung nodule.

12. The method according to claim 1, wherein said classifying step comprises the step of excluding non-nodule structures from further evaluation.

13. The method according to claim 12, wherein said excluding step comprises the step of applying a depth-first search to the seeds in a direction of a Z-axis of the VOI, to exclude any of the seeds representing the non-nodules structures.

14. The method according to claim 1, wherein said displaying step comprises the step of defining a bounding box for a current lung nodule to be displayed, the bounding box including the current lung nodule and any pre-specified background structures.

15. The method according to claim 1, wherein said displaying step comprises the step of refining a segmentation of the lung nodules to enhance detailed surface features of the lung nodules.

16. The method according to claim 1, wherein said displaying step comprises the step of rendering surfaces of the lung nodules to provide three-dimensional free rotation of the lung nodules.

17. The method according to claim 1, wherein said analyzing step comprises the step of receiving, from a user, a final detection decision for each of the lung nodules, the final detection decision overriding the automatic detection decision.

18. The method according to claim 1, further comprising the step of storing the automatic detection decision.

19. The method according to claim 17, further comprising the step of storing the final detection decision.

20. A system for automatically detecting lung nodules from Multi-Slice High Resolution Computed Tomography (MSHR CT) images, comprising the steps of:
a volume of interest selector for defining a volume of interest (VOI) based on MSHR CT image data corresponding to an MSHR CT image, the VOI for moving through a lung volume in the MSHR CT image;
a lung volume examination device for determining a local histogram of intensity inside the VOI, and for determining adaptive threshold values for segmenting the VOI to obtain seeds;
a seed examination device for examining each of the seeds to detect the lung nodules therefrom, including,
a segmentation device for segmenting anatomical structures represented by the seeds by applying a segmentation method to the seeds that adaptively adjusts a segmentation threshold value based on a local histogram analysis to extract the anatomical structures based on three-dimensional connectivity and intensity information corresponding to the local histogram; and
a classifier for classifying each of the segmented, anatomical structures as one of a lung nodule or a non-nodule, based on a priori knowledge corresponding to the lung nodules and related, pre-defined anatomical structures;
a display device for displaying the lung nodules; and
a detection device for automatically quantifying features of the lung nodules to provide an automatic detection decision for each of the lung nodules.

21. The system according to claim 20, wherein the lung volume examination device determines a curvature of a one-dimensional histogram curve corresponding to the local histogram.

22. The system according to claim 21, wherein the lung volume examination device determines positive and negative curvature extrema of the curvature of the one-dimensional histogram curve.

23. The system according to claim 22, wherein said lung volume examination device determines the adaptive segmentation threshold value based upon an analysis of positive and negative curvature extrema of the curvature of the one-dimensional histogram curve.

24. The system according to claim 20, wherein said seed examination device comprises a feature computation device for computing intensity and geometric features of the segmented, anatomical structures.

25. The system according to claim 24, wherein the intensity and geometric features are computed from at least some cutting cross-sections produced by a 360-degree-spin-plane method applied in the VOI, and the intensity and geometric features comprise at least some of a position, a volume, a circularity, a sphericity, and a mean and standard deviation of intensity.

26. The system according to claim 20, wherein the a priori knowledge comprises at least some of an intensity, a volume, and a shape of the lung nodules and the related, predefined anatomical structures.

27. The system according to claim 20, wherein said classifier excludes non-nodule structures from further evaluation.

28. The system according to claim 27, wherein said classifier applies a depth-first search to the seeds in a direction of a Z-axis of the VOI, to exclude any of the seeds representing the non-nodules structures.

29. The system according to claim 1, wherein said displaying device renders surfaces of the lung nodules to provide three-dimensional free rotation of the lung nodules.

30. The system according to claim 1, wherein said detection device receives, from a user, a final detection decision for each of the lung nodules, the final detection decision overriding the automatic detection decision.

31. The system according to claim 20, further comprising a storage device for storing the automatic detection decision.

32. The system according to claim 30, further comprising a storage device for storing the final detection decision.
